(19) United States
(12) Patent Application Publication
(10) Pub. No.: US 2018/0250858 A1
(43) Pub. Date: Sep. 6, 2018

(54) THE INJECTION GATE APPLICATION OF PLASTIC MATERIAL

(71) Applicants: Chao-Hung LIN, Taipei City (TW); Wei-Feng YEN, Taipei City (TW); Guess WEI, Taipei City (TW); Te-Shun LEE, Taipei City (TW); HEWLETT-PACKARD DEVELOPMENT COMPANY, L.P., Houston, TX (US)

(72) Inventors: Chao-Hung LIN, Taipei City (TW); Wei-Feng YEN, Taipei City (TW); Guess WEI, Taipei City (TW); Te-Shun LEE, Taipei City (TW)

(21) Appl. No.: 15/758,131

(22) PCT Filed: Nov. 3, 2015
(86) PCT No.: PCT/CN2015/093645

§ 371 Date: Mar. 7, 2018

(51) Int. Cl. B29C 45/27; B22C 9/08; B29C 33/00; B29C 39/24; B29C 39/40; B29C 45/00

(52) U.S. Cl. CPC B29C 45/27; B22C 9/082; B29C 33/0061; B29C 39/24; B29C 2045/0089; B29C 45/0046; B29C 45/0055; B29C 2045/0051; B29C 2045/0058; B29C 39/40

(57) ABSTRACT

Various examples provide a mold including a molding component and a supplementary component. The molding component may have a cavity, to enable a molten material to fill into the molding component to form an object. The supplementary component may include a bypass having a first opening located at a first position of the molding component and a second opening located at a second position of the molding component. The molten material may flow from the first position to the second position via the molding component, flow from the first opening to the second opening via the bypass and fill into the second position of the molding component through the second opening.

### BACKGROUND

Molding is a manufacturing process for producing parts by injecting material into a mold. Molding can be performed with various materials, such as metals, glasses, elastomers, confections, thermoplastic, thermosetting polymers, and the like. Molten material for the part may be forced into a mold cavity, where it cools and hardens to the configuration of the cavity.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 is a flowchart illustrating a molding method in accordance with an example of the present disclosure;

FIG. 2 is a sectional view showing a part of a mold in accordance with an example of the present disclosure;

FIG. 3 is a sectional view of a mold having a molding component and a bypass spanning a corner of the molding component in accordance with an example of the present disclosure;

FIG. 4a is a sectional view of a mold having a molding component and a bypass spanning a raised portion within the molding component in accordance with an example of the present disclosure;

FIG. 4b is a top view of the mold of FIG. 4a in accordance with an example of the present disclosure;

FIG. 5 is a sectional view of a mold having a molding component and a bypass spanning a narrowing section of the molding component in accordance with an example of the present disclosure;

FIG. 6 is a flowchart illustrating a molding method of producing an object in accordance with an example of the present disclosure;

FIG. 7 is a schematic diagram illustrating two halves of a mold in accordance with an example of the present disclosure;

FIG. 8a is a cross-sectional view of the mold of FIG. 7 with the two halves closed in accordance with an example of the present disclosure; and

FIG. 8b is a cross-sectional views of a model formed by solidified material after the mold is removed in accordance with an example of the present disclosure;

FIG. 8c is a side view of the model of FIG. 8b;

FIG. 8d is a schematic diagram illustrating an object obtained after a redundant part corresponding to a bypass of the mold is removed from the model in accordance with an example of the present disclosure;

FIG. 9 is a schematic diagram illustrating a mold in accordance with an example of the present disclosure;

FIG. 10a is a schematic diagram illustrating a model taken out from the mold of FIG. 9 with a rib corresponding to a bypass of the mold in accordance with an example of the present disclosure; and

FIG. 10b is a schematic diagram illustrating an object obtained by removing the rib from the model of FIG. 10a in accordance with an example of the present disclosure.

### DETAILED DESCRIPTION

Reference will now be made in detail to examples, which are illustrated in the accompanying drawings. In the following detailed description, numerous specific details are set forth in order to provide a thorough understanding of the present disclosure. Also, the figures are illustrations of examples, in which modules or procedures shown in the figures are not necessarily essential for implementing the present disclosure. In other instances, well-known methods, procedures, components, and circuits have not been described in detail so as not to unnecessarily obscure aspects of the examples.

Objects that may be produced by molding range widely from tiny parts of cell phones or toys to body panels of cars. After an object is designed, molds may be produced by a moldmaker and machined to form the features of the object. Molten material may be injected from a nozzle into the cavity of a mold through a runner and an ingress of the mold which is referred to as a gate, and flow to fill the cavity. When the material cools and solidifies to form a model, the model may be separated from the mold and processed to obtain the object. Hollows or indentations may occur on produced objects making the objects flawed. The hollows or indentations, also referred to as sink marks, may be a result of non-filled mold, lack of material, low injection speed or pressure, low temperature of the mold, or the like.

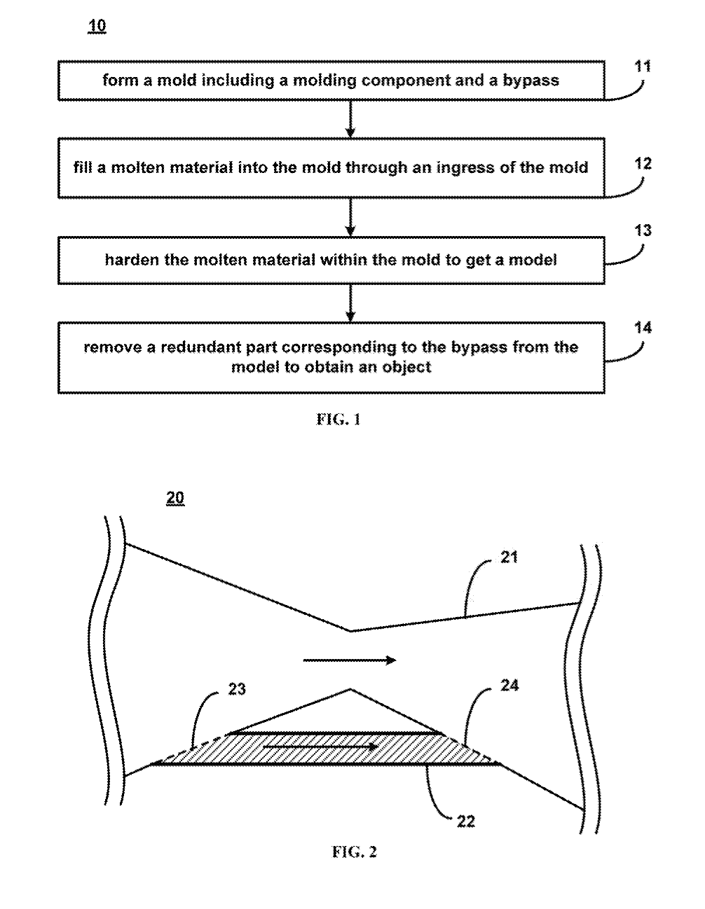

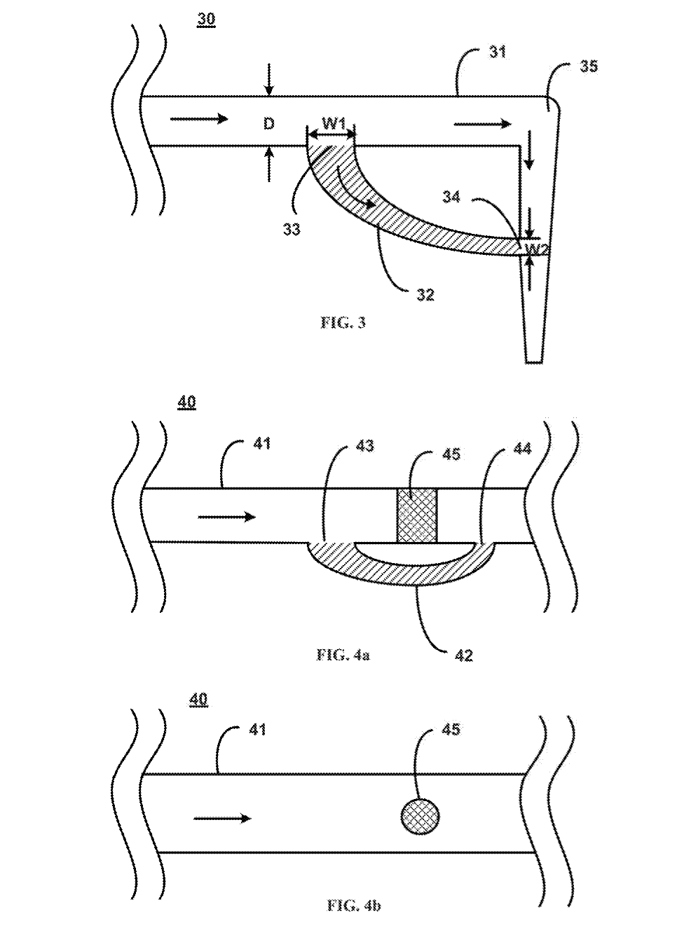

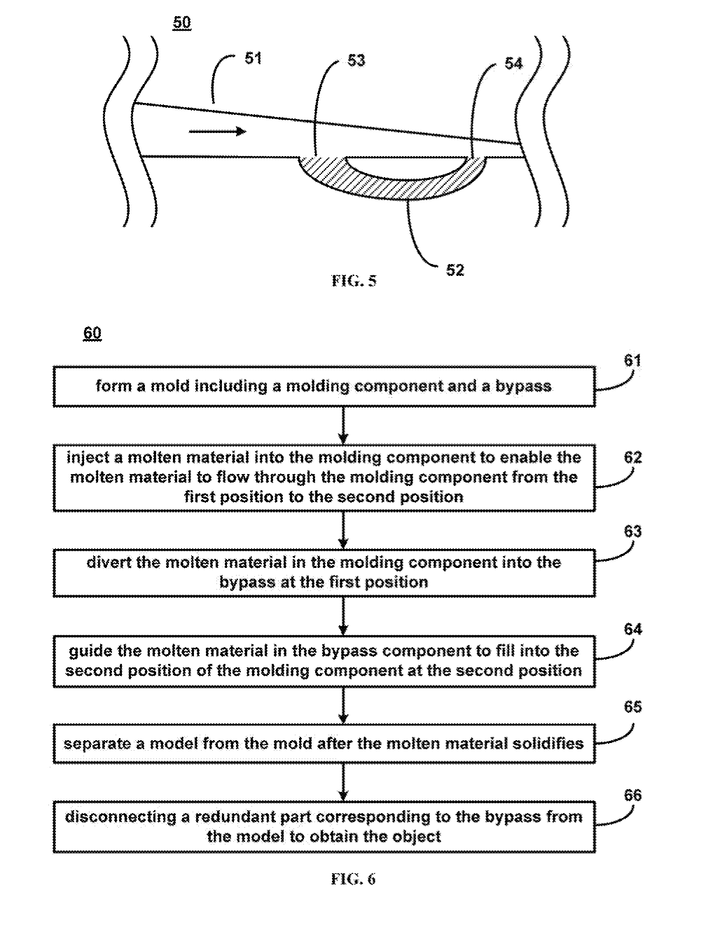

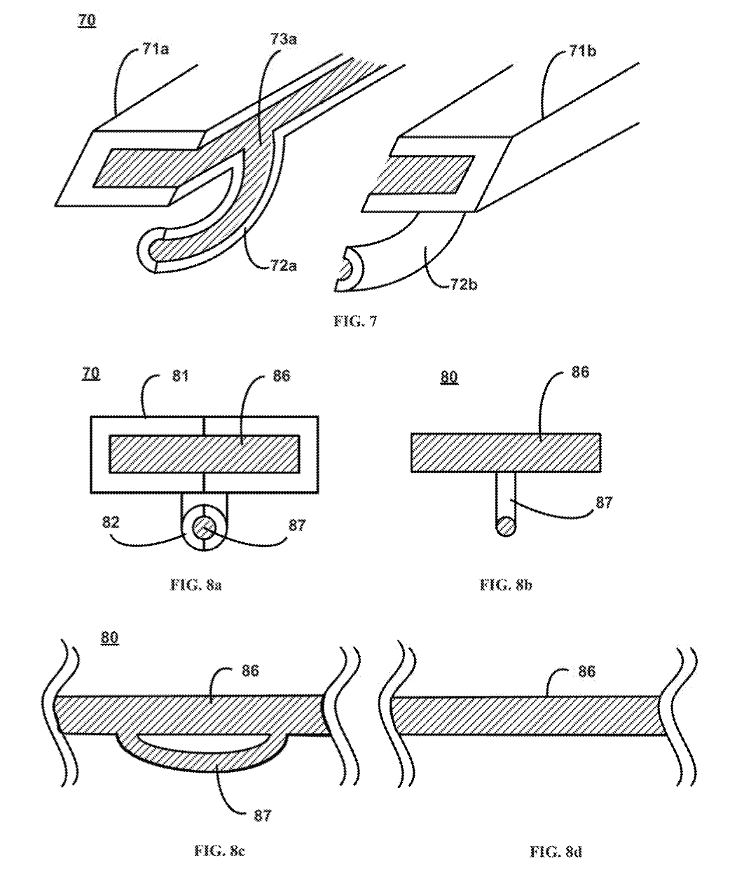

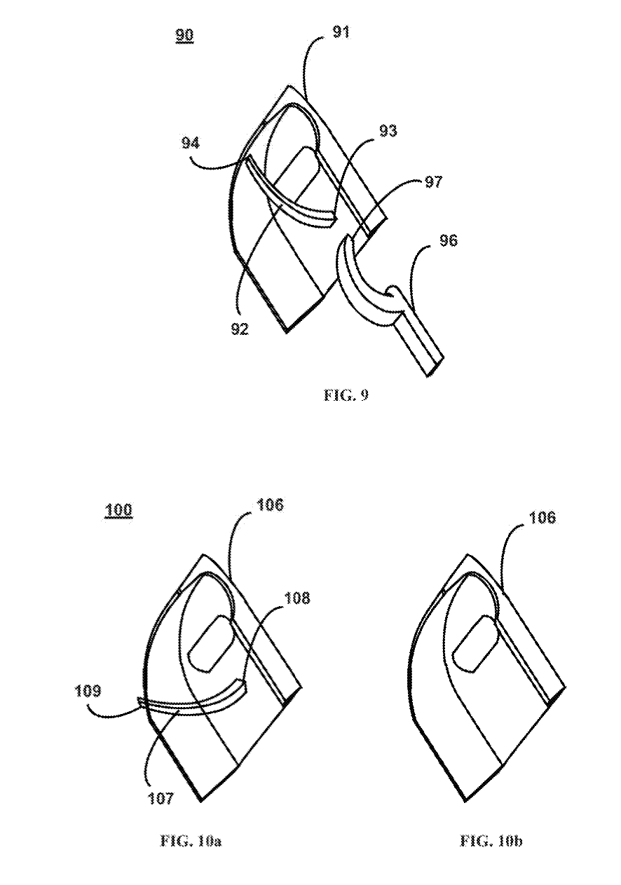

Various examples of the present disclosure provide a molding method of generating an object. FIG. 1 is a flowchart a molding method 10 in accordance with an example of the present disclosure, to improve filling effects. The molding method 10 may include the following procedures.

At block 11, a mold which includes a molding component and a bypass may be formed.

The molding component refers to a hollow component for molding an object. The molding component may have a cavity in the shape of the object, and a gate to allow a molten material to be filled into the molding component.

The bypass refers to a pipe-like component having both ends connected with the cavity of the molding component, for diverting the material to flow out of the molding component at a first position and re-enter the molding component at a second position. The bypass may have a first opening located at a first position of the molding component and a second opening located at a second position of the molding component. If the molten material flows from the first position to the second position, the first opening may be an ingress for the molten material to enter the bypass from the molding component, and the second opening may be an egress for the molten material to exit the bypass and flow into the molding component.

FIG. 2 is a sectional view showing a part of a mold 20 having a molding component 21 and a supplementary component 22 provided by an example. The molding component 21 may have a cavity, and enable a molten material to fill into the molding component to form an object. The supplementary component 22 may include a bypass having a first opening 23 located at a first position of the molding component 21 and a second opening 24 located at a second position of the molding component 21. In an example, the supplementary component 22 may include plural bypasses located at different positions of the mold.

At block 12, a molten material may be filled into the mold through an ingress of the mold.

The molten material refers to a material heated to a liquid state to be able to flow, and may harden when cools down to obtain a shape according to configurations of the mold. The material may be selected from a group including: metal, glass, elastomer, confection, thermoplastic, thermosetting polymer, and the like.

The molten material may be filled into the mold to enable the molten material to flow through the molding component from the first position to the second position, and enable the molten material to flow from the first opening to the second opening of the bypass and fill into the second position of the molding component via the second opening. In the example as shown in FIG. 2, the molten material may flow from the first position to the second position via the molding component 21, flow from the first opening 23 to the second opening 24 via the bypass and fill into the second position of the molding component 21 through the second opening 24.

In an example, the bypass may be heated to avoid the molten material cools down in the bypass. As such, flow speed of the molten material along the bypass can be maintained to improve filling effects.

At block 13, the molten material may harden within the mold to get a model.

The model refers to an initial part formed in the mold, and may undergo further processing to generate the target object. In an example, besides the object formed by the material solidified in the molding component of the mold, the model may also include a portion formed by the material solidified in the supplementary component of the mold, a portion formed by the material solidified in the runner through which the molten material is injected into the mold, and the like. Portions of the model that are not elements forming the object may be collectively referred to as redundant parts.

At block 14, a redundant part corresponding to the bypass may be removed from the model to obtain an object.

According to various examples, a mold having a molding component and a supplementary component can change the filling sequence of a molten material in the molding component and increase the amount of material filled into the second position of the molding component, thus can achieve better filling effects, e.g., reduce the filling time, reduce sink marks, or the like.

In an example, a bypass may be configured in the mold to span a section of the molding component to increase the amount of material flowing over the section within a short time, to shorten the time it takes to fill the molding component. For example, a bypass may be configured in a mold to guide the molten material to a first end of the molding component that is farther from the ingress (i.e., the gate) of the mold than a second end of the molding component. Thus, the first end of the molding component may be filled as quickly as the second end, and the filling time of the mold can be reduced.

In another example, a bypass may be configured in the mold to span a section having an irregular shape, e.g., including a curve, an angle, uneven inner surface of the molding component, narrowing cavity, or the like. The irregular shape of the section of the molding component may change the flow direction or reduce the flow speed of the molten material within the molding component between the first position and the second position or leave some positions hard to be filled, and sink marks may occur. The bypass may enable the molten material to bypass the irregular-shaped section of the molding component and directly reach a remote section beyond the irregular-shaped section. As such, positions that may be hard to reach by the molten material flowing within the molding component can be filled with the molten material diverted by the bypass, and sink marks can be reduced. The following are several examples of configurations of a bypass in a mold. As used herein, “a remote section beyond the irregular-shaped section” refers to a section located farther from an ingress or a gate of the mold via which the molten material is filled into the mold, i.e., the molten material may flow to the irregular-shaped section before flowing to the remote section when flowing along the cavity of the molding component.

In an example, a bypass may be configured at a section of the molding component where there is a corner. As used herein, a corner refers to a section of the molding component where there is a curve or an angle, and may force a liquid in the cavity to change a flow direction at the section. FIG. 3 is a sectional view of a mold 30 having a molding component 31 and a bypass 32 spanning a corner 35 of the molding component 31. The bypass 32 may have a first opening 33 located at a first leg of the corner 35 and a second opening 34 at the second leg of the corner 35. The molten material may be filled into the molding component 31 to flow along the first leg of the corner 35 and change the flow direction to flow around the corner 35 to the second leg of the corner 35. The change in flow direction may cause a slowdown in the flow speed in the molding component, and sink marks may occur at the outer part of the corner 35 and at the remote section of the second leg. The bypass 32 may guide the molten material to flow out of the molding component 31 via the first opening 33, flow along the bypass 32 and be filled into the molding component 31 again via the second opening 34. The molten material diverted by the bypass 32 may directly and quickly fill the remote section beyond the second opening 34, thus filling time can be reduced and sink marks may be reduced at the remote end. In addition, the portion of molten material flowing to the second leg of the corner 35 within the molding component 31 may be blocked by the molten material flowing out from the second opening 34, and piled up in the corner 35, thus sink marks may be reduced or eliminated at the corner 35.

In an example, a bypass may be configured at a section of the molding component where there is a raised portion or a depressed portion. A raised portion in a molding component refers to a projecting portion sticking into the cavity of the molding component to form a depression or a hole in the produced object. A depressed portion in a molding component refers to a hollow or a hole in the inside wall of the molding component to form a sticking out portion on the outer surface of the produced object. FIG. 4a is a sectional view of a mold 40 having a molding component 41 and a bypass 42 spanning a section where there is a raised portion 45 sticking out into the cavity of the molding component 41. FIG. 4b is a top view of the mold of FIG. 4a. The raised portion 45 may block the flow of the molten material at one side of the raised portion 45, and shade an area on the other side of the raised portion 45 so that the shaded area is hard to be reached by the molten material, which may cause a sink mark. The bypass 42 may divert the molten material via a first opening 43 to the back of the raised portion 45, so that the molten material may reach the shaded area from a second opening 44 of the bypass 42. In addition, since the raised portion 45 may block the flow of the molten material to slow down the flow of the molten material, the bypass 42 diverting the molten material may increase the amount of molten material reaching sections beyond the raised portion 45, thus the filling time can be shortened. Examples where the molding component has a depressed portion are similar to the above example, thus are not described further herein.

In an example, a bypass may be configured at a narrowing section of the molding component. FIG. 5 is a sectional view of a mold 50 having a molding component 51 and a bypass 52 spanning a narrowing section of the molding component 51. As shown in FIG. 5, the cavity of the molding component 51 may narrow down in the flow direction of the molten material. The bypass 52 may have a first opening 53 located at a first position and a second opening 54 located at a second position. The cavity is narrower at the second position than at the first position. The bypass 52 may divert the molten material out of the molding component 51 via the first opening 53 and re-enter the molding component 51 via the second opening 54. As such, the molten material flowing out of the bypass 52 may improve filling effects at sections beyond the narrowing section.

In an example, the size of the first opening of the bypass may be determined according to the size of the cross-section of the cavity at the first position in the molding component. The size may refer to the area, width, diameter, or the like. For example, the width of the first opening may be smaller than the depth of the molding component at the first position, i.e., the depth of the cavity at the first position. Referring to the example as shown in FIG. 3, the width of the first opening 33 may be denoted by W1, and the depth of the cavity at the first position may be denoted by D. In an example, W1 may be smaller than 80% of D, e.g., 30% of D, 50% of D, 60% of D, or the like. As such, a proper portion of the molten material may be diverted while there may still be an adequate amount of molten material flowing within the molding component.

In an example, the size of the first opening of the bypass may be larger than or equal to the size of the second opening. The size may refer to the area, width, diameter, or the like. Referring to FIG. 3 as an example, the width of the first opening 33 may be denoted by W1, and the width of the second opening may be denoted by W2. In an example, W1 may be larger than W2. After the molten material hardens in the mold, a redundant part corresponding to the bypass may be connected to the object corresponding to the molding component via two joints. Each of the two joints corresponds to one of the first opening and the second opening. A first joint corresponding to the second opening may be smaller in the cross-sectional area than the second joint corresponding to the first opening, thus, the second joint may be disconnected by forcing the model out of the mold if the model is made of an elastic material and the model can be taken out of the mold.

According to various examples, an object may be produced through a molding process using the mold of various examples. As shown in FIG. 6, an object may be produced through the following procedures.

At block 61, a mold including a molding component and a bypass may be formed. Each bypass may have a first opening located at a first position of the molding component and a second opening located at a second position of the molding component.

The molding component may have a cavity for forming the object to be produced. One or plural bypasses may be formed on the molding component. A bypass may be formed at any position of the molding component to improve filling effects at the position. In an example, the first opening of the bypass may be formed at a position near the gate through which the molten material is filled into the mold. The second opening may be formed at a position far from the gate or having a barrier in the molding component which may block the flow of the molten material through the cavity, i.e., a position that is hard or time-consuming for the molten material to flow to along the cavity.

At block 62, a molten material may be injected into the molding component to enable the molten material to flow through the molding component from the first position to the second position.

At block 63, the molten material in the molding component may be diverted into the bypass at the first position.

In an example, the molding component and the bypass may be heated to maintain the fluidity of the molten material.

At block 64, the molten material in the bypass component may be guided to fill into the second position of the molding component at the second position.

At block 65, a model may be separated from the mold after the molten material hardens.

The molten material may form a model within the mold after solidified. The model may be separated from the mold in different ways depending on the type of the mold. If the mold is a two-piece mold, i.e., the mold may have two halves which close to form the complete mold, the model may be separated from the mold by splitting the two halves to open the mold. If the mold is a one-piece mold having an open cavity, there may be a mechanism, e.g., an ejector pin, or the like, to pull out or eject the model from the mold.

At block 66, a redundant part corresponding to the bypass may be disconnected from the model to obtain the object.

The redundant part refers to a portion of the model that is formed by the molten material in the bypass. Since the molding component is the component for forming the shape of the object to be produced and the bypass is a supplementary to the molding component for improving filling effects, the part formed in the bypass is an unwanted part and may be removed from the model. The redundant part may be removed in a manner corresponding to the material of the object. For example, if the object is made of metal, the redundant part may be cut off by flame cutting, laser cutting, or the like. If the object is made of a soft material, e.g., plastic or elastomer, the redundant part may be cut off using a blade, or the like.

Through the above process, a product (i.e., the object) can be produced using the mold of various examples with improved appearance and reduced flaws. The design of the mold including the molding component and the supplementary component may be applied to various types of molds, e.g., bi-valve molds (i.e., having two molds, one for each half of the object), one-piece molds, or the like.

FIG. 7 is a schematic diagram illustrating two halves of a bi-valve mold 70. As shown in FIG. 7, the mold 70 may be formed to have a molding component including two molding halves 71a and 71b. The mold 70 may also have a bypass, and the bypass includes two bypass halves 72a and 72b. The bypass may have a first opening 73a connected to a cavity of the molding component. The bypass may also have a second opening (not shown) connected to the cavity at another position for diverting a molten material through the bypass. When the two halves of the mold 70 close together, a closed cavity and a pipe serving as the bypass may be formed within the mold 70. FIG. 8a is a cross-sectional view of the mold of FIG. 7 with the two halves closed. As shown in FIG. 8a, the mold 70 may have a molding component 81 and a bypass 82. A molten material may be filled into the mold 70 to flow along the cavity. The bypass may divert a portion of the molten material from the first opening 73a and guide the molten material to fill into the cavity through the second opening. After the molten material hardens, a model may be formed which include a first part 86 and a second part 87. The first part 86 may have the shape of the cavity of the molding component 81, i.e., the object. The second part 87 may be a by-product of the bypass 82 which is an unwanted part, i.e., a redundant part.

FIG. 8b is a cross-sectional view of the model formed in the mold 70. As shown in FIG. 8b, the two halves of the mold 70 may be split to have the model separated from the mold. The model may include an object 86 having the shape of the cavity and a redundant part 87 having the shape of the bypass 87. FIG. 8c is a side view of the model of FIG. 8b which includes the object 86 and the redundant part 87. The redundant part may be cut off from the model to produce the object 86. FIG. 8d is a schematic diagram illustrating an object obtained after the redundant part 87 is cut off from the model as shown in FIG. 8c.

FIG. 9 is a schematic diagram illustrating a one-piece mold 90. The mold 90 may include a molding component 91 and a bypass 92. The molding component 91 may have a cavity (not shown) on the upper surface. The bypass 92 is connected to the molding component 91 via a first opening 93 at a first position of the molding component 91 and a second opening 94 at a second position of the molding component 91. A filling mechanism 96 may fill a molten material into the molding component 91 via a gate 97. The molten material may flow in the cavity along the molding component 91 from the first position to the second position. A portion of the molten material may flow through the first opening 93 out of the molding component 91, be guided by the bypass to re-enter the cavity of the molding component 91 via the second opening 94 to improve filling effects at the second position of the molding component 91.

After the molten material solidifies in the mold 90, both in the molding component 91 and in the bypass 92, to form a model having an object corresponding to the molding component 91 and a redundant part corresponding to the bypass 92. The redundant part is formed to be connected to the object through two joints corresponding to the first opening 93 and the second opening 94. In an example, the second opening 94 may be smaller than the first opening 93, and the model may be forced out of the mold, e.g., by an ejection pin. Since the second opening 94 is smaller than the first opening 93, the joint corresponding to the second opening 94 may be forced to be disconnected while the model is taken out of the mold 90 with the redundant part pulled out of the bypass along with the model. The redundant part may be connected with the object through the joint corresponding to the first opening 93, forming a rib. FIG. 10a shows the model 100 taken out from the mold 90 of FIG. 9 with a rib 107. The model 100 may include an object 106 having the shape of the cavity of the molding component and the rib 109 corresponding to the bypass. The rib 109 may be connected with the object 106 through a joint 108 corresponding to the first opening. The rib 109 may be sheared off the model 100 to generate the object 106 as shown in FIG. 10b.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the present disclosure and its practical applications, to thereby enable others skilled in the art to best utilize the present disclosure and various examples with various modifications as are suited to the particular use contemplated. All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. A mold, comprising:
a molding component having a cavity, to enable a molten material to fill into the molding component to form an object; and
a supplementary component including a bypass having a first opening located at a first position of the molding component and a second opening located at a second position of the molding component;
wherein the molten material flows from the first position to the second position via the molding component, flows from the first opening to the second opening via the bypass and fills into the second position of the molding component through the second opening.

2. The mold according to claim 1, wherein a first section of the molding component between the first position and the second position has an irregular shape.

3. The mold according to claim 2, wherein the first section has a corner.

4. The mold according to claim 2, wherein the first section has an irregular inside including a raised portion and/or a depressed portion.

5. The mold according to claim 2, wherein the first section narrows down from the first position to the second position.

6. The mold according to claim 1, wherein the size of the first opening is larger than the size of the second opening.

7. The mold according to claim 1, wherein a size of the first opening is smaller than a size of a cross-section of the cavity at the first position.

8. A molding method, comprising:
forming a mold including a molding component and a bypass, wherein the bypass has a first opening located at a first position of the molding component and a second opening located at a second position of the molding component;
filling a molten material into the mold through an ingress of the mold, to enable the molten material to flow through the molding component from the first position to the second position, and enable the molten material to flow from the first opening to the second opening of the bypass and fill into the second position of the molding component via the second opening;
hardening the molten material within the mold to get a model; and
removing a redundant part corresponding to the bypass from the model to obtain an object.

9. The molding method according to claim 8, wherein the size of an ingress of the bypass is larger than the size of an egress of the bypass,
wherein the method further comprises: forcing the model away from the mold to disconnect the redundant part from the model at the egress of the bypass and pull the redundant part out of the bypass through the ingress of the bypass along with the model.

10. The molding method according to claim 8, wherein forming a mold including a molding component and a bypass comprises:
forming the bypass where a first section of the molding component between the first position and the second position has an irregular shape.

11. The molding method according to claim 10, wherein the first section has the irregular shape selected from a group comprising: a corner, a narrowing shape, an irregular inside including a raised portion and/or a depressed portion.

12. A product, produced through a molding process comprising:
forming a mold including a molding component and a bypass, wherein the bypass has a first opening located at a first position of the molding component and a second opening located at a second position of the molding component;
injecting a molten material into the molding component to enable the molten material to flow through the molding component from the first position to the second position;
diverting the molten material in the molding component into the bypass at the first position;
guiding the molten material in the bypass component to fill into the second position of the molding component at the second position;
separating a model from the mold after the molten material hardens; and
disconnecting a redundant part corresponding to the bypass from the model to obtain the product.

13. The product according to claim 12, wherein the cross-sectional area of a first joint between the redundant part and the model at the first position is larger than the cross-sectional area of a second joint between the part and the redundant part at the second position, and the redundant part is sheared off the model at the second joint when the part is taken out of the mold by force.

14. The product according to claim 12, wherein diverting the molten material in the molding component into the bypass at the first position comprises:
diverting the molten material in the molding component into the bypass at the first position where a first section of the molding component between the first position and the second position has an irregular shape.

15. The product according to claim 12, wherein the product is made of a material selected from a group comprising: metal, glass, elastomer, confection, thermoplastic, and thermosetting polymer.
